(19) United States
(12) Patent Application Publication
(10) Pub. No.: US 2025/0376126 A1
(43) Pub. Date: Dec. 11, 2025

(54) METHOD, UNIT, AND SYSTEM FOR DETERMINING WHETHER A VEHICLE IS UNDERGOING A ROLLOVER

(71) Applicant: Robert Bosch GmbH, Stuttgart (DE)

(72) Inventor: Huimin Shan, Suzhou (CN)

(21) Appl. No.: 19/227,869

(22) Filed: Jun. 4, 2025

(30) Foreign Application Priority Data
Jun. 5, 2024 (CN) 2024 1072 5024.7

(51) Int. Cl. B60R 21/0132; B60R 21/00

(52) U.S. Cl. CPC B60R 21/0132; B60R 2021/0018

(57) ABSTRACT

A method, unit, and system for determining whether a vehicle is undergoing a rollover is disclosed. The vehicle includes: a first acceleration sensor configured to sense a first lateral acceleration at a first side in the lateral direction; a second acceleration sensor configured to sense a second lateral acceleration at a second side in the lateral direction; and a third acceleration sensor configured to sense a third lateral acceleration at an intermediate portion in the lateral direction. The method includes: selecting the greater acceleration from the first acceleration and the second acceleration; determining whether a difference between the greater acceleration and the third acceleration exceeds a difference threshold; integrating the difference over time during each of a plurality of consecutive time periods to generate a plurality of integration values; determining whether a majority of the plurality of integration values exceed an integration threshold; and when it is determined that a majority of the plurality of integration values exceed the integration threshold, determining that the vehicle is undergoing a rollover; and when it is determined that a majority of the plurality of integration values are less than or equal to the integration threshold, determining that the vehicle is not undergoing a rollover.

This application claims priority under 35 U.S.C. § 119 to application no. CN 2024 1072 5024.7,filed on Jun. 5, 2024 in China, the disclosure of which is incorporated herein by reference in its entirety.

The present application relates to the field of vehicle safety technology, and more particularly, to a method, unit, and system for determining whether a vehicle is undergoing a rollover.

### BACKGROUND

Currently, based on certain mandatory standards, program products for determining whether a vehicle is undergoing a rollover have been embedded in the electronic control units (AB ECU) of some vehicle airbag systems. This enables the AB ECU to determine, based on angular velocity signals from the gyroscope sensor of the airbag system and, optionally, acceleration signals from an acceleration sensor, whether the vehicle is undergoing a rollover.

However, how to timely upgrade the airbag system to comply with mandatory standards in cases where the airbag system itself does not have a gyroscope sensor remains a challenge.

### SUMMARY

The objective of the present application is to provide improved methods, units, and systems for determining whether a vehicle is undergoing a rollover, so as to address the technical problems existing in the prior art.

To this end, according to one aspect of the present application, a method for determining whether a vehicle is undergoing a rollover is provided. The vehicle comprises: a first acceleration sensor, mounted on a first side of the vehicle in the lateral direction and configured to sense a first acceleration of the first side in the lateral direction; a second acceleration sensor, mounted on a second side of the vehicle opposite to the first side in the lateral direction and configured to sense a second acceleration of the second side in the lateral direction; a third acceleration sensor, mounted on an intermediate portion of the vehicle between the first side and the second side in the lateral direction and configured to sense a third acceleration of the intermediate portion in the lateral direction; wherein the method comprises: acquiring the first acceleration, the second acceleration, and the third acceleration; selecting the greater acceleration from the first acceleration and the second acceleration; determining that a difference between the greater acceleration and the third acceleration exceeds a difference threshold; integrating the difference over time during each of a plurality of consecutive time periods to generate a plurality of integration values; determining whether a majority of the plurality of integration values exceed the integration threshold; when it is determined that a majority of the plurality of integration values exceed the integration threshold, determining that the vehicle is rolling over about its longitudinal axis; and when it is determined that a majority of the plurality of integration values are less than or equal to the integration threshold, determining that the vehicle is not rolling over about its longitudinal axis.

According to another aspect of the present application, a unit for determining whether a vehicle is undergoing a rollover is provided. The unit comprises: a processor; and a memory storing executable instructions, which, when executed, cause the processor to perform the method for determining whether a vehicle is undergoing a rollover.

According to yet another aspect of the present application, a system for determining whether a vehicle is undergoing a rollover is provided. The system comprises: a first acceleration sensor, mounted on a first side of the vehicle in the lateral direction and configured to sense a first acceleration of the first side in the lateral direction; a second acceleration sensor, mounted on a second side of the vehicle opposite to the first side in the lateral direction and configured to sense a second acceleration of the second side in the lateral direction; a third acceleration sensor, mounted on an intermediate portion of the vehicle between the first side and the second side in the lateral direction and configured to sense a third acceleration of the intermediate portion in the lateral direction; and a unit for determining whether a vehicle is undergoing a rollover, the unit being communicatively connected to the first acceleration sensor, the second acceleration sensor, and the third acceleration sensor, wherein the first acceleration sensor, the second acceleration sensor, and the third acceleration sensor are respectively mounted on the first side, the second side, and the intermediate portion at the same height in the lateral direction.

The method, unit, and system for determining whether a vehicle is undergoing a rollover provided by the present application can estimate the roll angle of the vehicle about its longitudinal axis and the rate of change of the roll angle without using a gyroscope sensor, but instead by utilizing the first, second, and third acceleration sensors of the vehicle. This enables determination of whether the vehicle is undergoing a rollover, and further allows the difference in duration between a rollover event and a side collision event to be considered, thereby accurately distinguishing whether the vehicle is undergoing a rollover or a side collision.

### BRIEF DESCRIPTION OF THE DRAWINGS

The exemplary embodiments of the present application will be described in detail below with reference to the accompanying drawings. It should be understood that the embodiments described below are merely for the purpose of illustrating the present application and are not intended to limit the scope of the present application.

In the accompanying drawings,

FIG. 1 is a block diagram of a system for determining whether a vehicle is undergoing a rollover according to one embodiment of the present application, wherein the system may include a unit for determining whether a vehicle is undergoing a rollover according to one embodiment of the present application, and the unit may implement the method for determining whether a vehicle is undergoing a rollover according to one embodiment of the present application;

FIG. 2 is a schematic diagram illustrating the principle of the unit shown in FIG. 1;

FIG. 3 is a flowchart of the method that may be implemented by the unit shown in FIG. 1;

FIG. 4 is a flowchart of one step of the method that may be implemented by the unit shown in FIG. 1;

FIG. 5 is a chart that may be generated by the system shown in FIG. 1; and

FIG. 6 is a chart that may be generated by the system shown in FIG. 1.

### DETAILED DESCRIPTION

The various exemplary embodiments of the present application will now be described in detail with reference to the accompanying drawings. It should be noted that, unless otherwise specifically stated, the relative arrangement of the components and steps, numerical expressions, and values set forth in these embodiments do not limit the scope of the present application.

Techniques and equipment known to those of ordinary skill in the relevant art may not be discussed in detail herein; however, where appropriate, such techniques and equipment should be regarded as part of the specification.

In all examples illustrated and discussed herein, any specific values should be interpreted as being merely illustrative and not as limiting. Accordingly, other examples of the exemplary embodiments may have different values.

It should be noted that, similar reference numerals and letters indicate similar items in the following figures. Therefore, once an item is defined in one figure, further discussion thereof in subsequent figures is not necessary.

For certain vehicles, in cases where the airbag system itself is not equipped with a gyroscope sensor, the vehicle is unable to detect the angular velocity about its longitudinal axis. As a result, the airbag ECU (AB ECU) is also unable to determine whether the vehicle is undergoing a rollover, which is not permissible under certain mandatory standards.

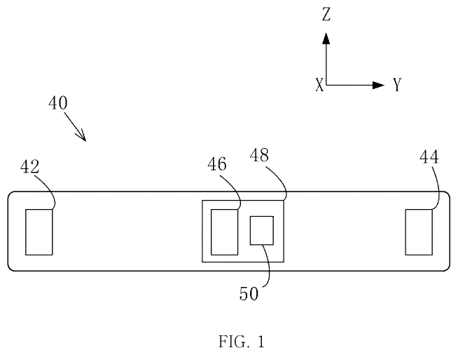

Accordingly, with reference to FIG. 1, the present application provides a system 40 (hereinafter referred to as “system 40”) for determining whether a vehicle is undergoing a rollover, without the need to add a gyroscope sensor to the vehicle. In general, system 40 may comprise at least two side impact sensors, namely, a first acceleration sensor 42 and a second acceleration sensor 44. The first acceleration sensor 42 is mounted on the vehicle (for example, on the front beam of the vehicle body or another suitable location) on a first side in the lateral direction (the direction indicated by the Y-axis in the vehicle coordinate system), and is configured to sense a first (linear) acceleration in the lateral direction on the first side. The second acceleration sensor 44 is mounted on the vehicle on a second side opposite to the first side in the lateral direction, and is configured to sense a second (linear) acceleration in the lateral direction on the second side. System 40 may further comprise a third acceleration sensor 46, which is mounted on an intermediate portion of the vehicle located between the first side and the second side in the lateral direction. The intermediate portion is near or on the chassis of the vehicle, and the AB ECU 48 is also disposed on the chassis. Thus, the third acceleration sensor 46 may be located on or near the AB ECU 48. Additionally, the intermediate portion or the AB ECU 48 may be regarded as the lateral center of the vehicle. The third acceleration sensor 46 is configured to sense a third (linear) acceleration in the lateral direction at the intermediate portion. It is understood that existing vehicles, especially airbag systems, can generally be equipped with the aforementioned sensors. The first acceleration sensor 42 mounted on the first side, the second acceleration sensor 44 mounted on the second side, and the third acceleration sensor 46 mounted on the intermediate portion may be arranged at the same height along the lateral direction of the vehicle. Specifically, the first acceleration sensor 42, the second acceleration sensor 44, and the third acceleration sensor 46 may be distributed along the same lateral axis in the lateral direction.

Furthermore, system 40 also comprises a unit 50 (hereinafter referred to as “unit 50”) for determining whether the vehicle is undergoing a rollover. Unit 50 includes: a processor; and a memory storing executable instructions, which, when executed, cause the processor to perform the method for determining whether a vehicle is undergoing a rollover. For example, unit 50 may be embedded within the AB ECU 48, or unit 50 may be a virtual unit 50 formed by multiple parts distributed among other different controllers in the vehicle.

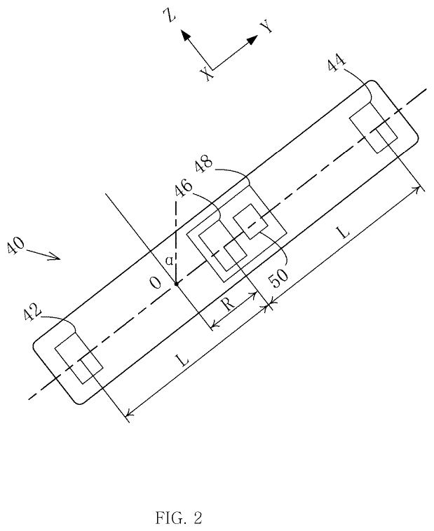

FIG. 2 illustrates a scenario in which, due to various events (including the vehicle encountering possible steep slopes, potholes, sand slippage, side impacts, rollovers, etc.), the vehicle begins to rotate counterclockwise about its longitudinal axis (in FIG. 2, the longitudinal axis is parallel to the X-axis in the vehicle coordinate system, i.e., perpendicular to the plane of the drawing). In this scenario, the first acceleration sensor 42 will sense a first acceleration on the first side, which corresponds to the component in the lateral direction of the first centripetal acceleration and gravitational acceleration of the first side relative to the rollover center O on the longitudinal axis. Similarly, the second acceleration sensor 44 will sense a second acceleration on the second side, which corresponds to the component in the lateral direction of the second centripetal acceleration and gravitational acceleration of the second side relative to the rollover center O. The third acceleration sensor 46 will sense a third acceleration at the central portion, which corresponds to the component in the lateral direction of the third centripetal acceleration and gravitational acceleration of the central portion relative to the rollover center O. The relationships among the first, second, and third accelerations are as follows:

$$ay\_ 1 = g \times sin α - {ω}^{2} \times ( L - R ) \qquad ( 1 )$$

$$ay\_ 2 = g \times sin α + {ω}^{2} \times ( L + R ) \qquad ( 2 )$$

$$ay\_ 3 = g \times sin α + {ω}^{2} \times R \qquad ( 3 )$$

where ay_1 is the first acceleration, ay_2 is the second acceleration, ay_3 is the third acceleration, g is the gravitational acceleration, α is the angle between the lateral direction of the vehicle and the vertical direction of the ground during rollover, ω is the angular velocity of the vehicle rotating about the rollover center O, L is the lateral distance between the first acceleration sensor 42 and the third acceleration sensor 46, or between the second acceleration sensor 44 and the third acceleration sensor 46, and R is the lateral distance between the third acceleration sensor 46 and the rollover center O. It is understood that equations (1)-(3) apply when the vehicle is at least partially in contact with the ground.

From equations (1)-(3), it can be seen that, in the scenario shown in FIG. 2:

$$ay\_ 2 - ay\_ 3 = {ω}^{2} \times L \qquad ( 4 )$$

$$ay\_ 3 - ay\_ 1 = {ω}^{2} \times L \qquad ( 5 )$$

From equations (4) and (5), it can be seen that the second acceleration is greater than the third acceleration, and the third acceleration is greater than the first acceleration. It is understood that equations (4)-(5) apply regardless of whether the vehicle is at least partially in contact with the ground or is already airborne.

It is further understood that, when the vehicle begins to rotate clockwise about its longitudinal axis due to various events, it is also possible for the first acceleration to be greater than the third acceleration, and for the third acceleration to be greater than the second acceleration.

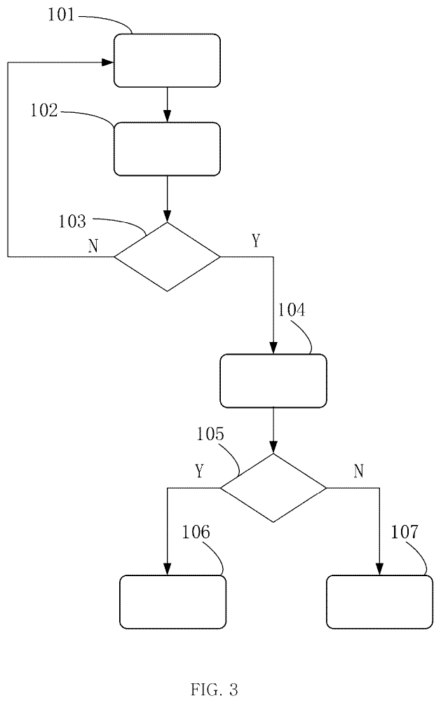

Unit 50 is communicatively connected to each acceleration sensor to perform the steps of the method for determining whether the vehicle is undergoing a rollover, as illustrated in FIG. 3. For example, unit 50 may obtain a first piezoelectric signal representing the first acceleration from the first acceleration sensor 42, a second piezoelectric signal representing the second acceleration from the second acceleration sensor 44, and a third piezoelectric signal representing the third acceleration from the third acceleration sensor 46, for processing and calculation. Herein, the signals may take various forms, and therefore, the method described herein will directly refer to the parameters represented by each signal.

In Step 101, the first acceleration, second acceleration, and third acceleration are acquired.

In Step 102, the greater acceleration is selected from the first acceleration and the second acceleration for subsequent estimation of the angular velocity of the vehicle about the rollover center O. Utilizing the greater acceleration is advantageous for improving the accuracy of the estimation. Generally, the acceleration sensor located farther from the rollover center O will detect a greater acceleration.

In Step 103, it is determined whether the difference between the larger acceleration and the third acceleration exceeds a difference threshold. For example, the difference threshold may be determined at least based on the product of the distance between the first acceleration sensor 42 and the third acceleration sensor 46 and the square of a preset angular velocity, wherein the preset angular velocity indicates the angular velocity that the vehicle should have at the onset of a rollover.

Optionally, the acquired first acceleration, second acceleration, and third acceleration may be subjected to low-pass filtering to eliminate interference in the estimation caused by signals collected by the first acceleration sensor 42, second acceleration sensor 44, and third acceleration sensor 46 during high-frequency vibrations of the vehicle. Additionally or alternatively, offset elimination may be performed on the acquired first, second, and third accelerations to exclude the influence of signal offsets collected by the first acceleration sensor 42, second acceleration sensor 44, and third acceleration sensor 46 during normal driving on the estimation.

If it is determined that the difference between the larger acceleration and the third acceleration is less than or equal to the difference threshold, this indicates that the vehicle is still in normal driving, and thus, the process may return to Step 101.

If it is determined that the difference between the larger acceleration and the third acceleration is greater than the difference threshold, this indicates that the vehicle may be starting to roll over. Therefore, in Step 104, the difference is integrated over time during a time period (e.g., window integration) to generate an integration value. According to the above equations (4) and (5), the integration value is the time integral of the square of the angular velocity of the vehicle about the rollover center O during the time period, reflecting the rate of change of the vehicle's rollover angle about the rollover center O. It is understood that, by looping, the difference may be integrated over time during each of a plurality of consecutive time periods (e.g., window integration) to generate a plurality of integration values.

In Step 105, it is determined whether a majority of the plurality of integration values exceed an integration threshold P. For example, the integration threshold P may be determined at least based on the time integral (e.g., window integration) of the product of the distance between the first acceleration sensor 42 and the third acceleration sensor 46 and the square of the preset angular velocity.

If it is determined that a majority (e.g., all) of the plurality of integration values exceed the integration threshold P, this indicates that the rollover angle of the vehicle about the rollover center O is continuously and rapidly increasing. Therefore, in Step 106, unit 50 determines that the vehicle is undergoing a rollover and sends a signal indicating that the vehicle is rolling over to a relevant vehicle controller or to the cloud.

If it is determined that a majority of the plurality of integration values are less than or equal to the integration threshold P, this indicates that the rollover angle of the vehicle about the rollover center O is not continuously and rapidly increasing, and thus the conditions for continuous rollover about the rollover center O leading to a rollover are not met. Therefore, in Step 107, unit 50 determines that the vehicle is not undergoing a rollover. However, unit 50 may still send a signal to a relevant vehicle controller or to the cloud requesting user confirmation of the vehicle status.

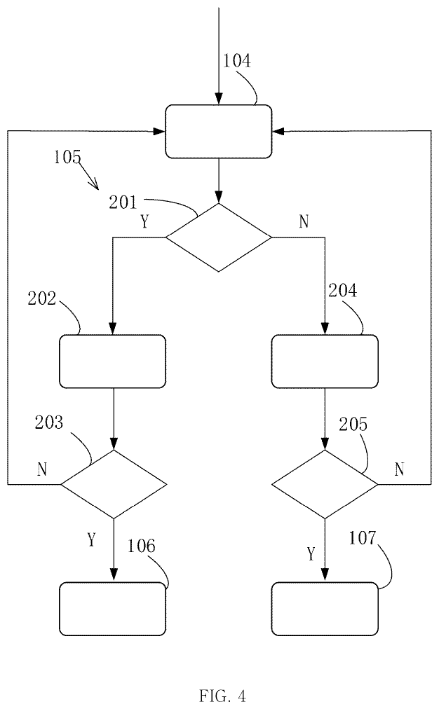

Optionally, the method may further include: Providing a counter or count value, i.e., unit 50 includes a counter having a count value; and setting an initial value N0 for the count value, a first count threshold N1 greater than the initial value N0, a second count threshold N2 less than the initial value N0, and a step size for the counter. Meanwhile, as shown in FIG. 4, Step 105 further includes Steps 201-205.

In Step 201, it is sequentially determined, in a loop, whether one of the plurality of integration values exceeds the integration threshold P. For example, in Step 104, the difference is integrated over time during the Mth time period to generate the Mth integration value, and in Step 201, it is determined whether the Mth integration value exceeds the integration threshold P. It is understood that M is a positive integer greater than or equal to 1.

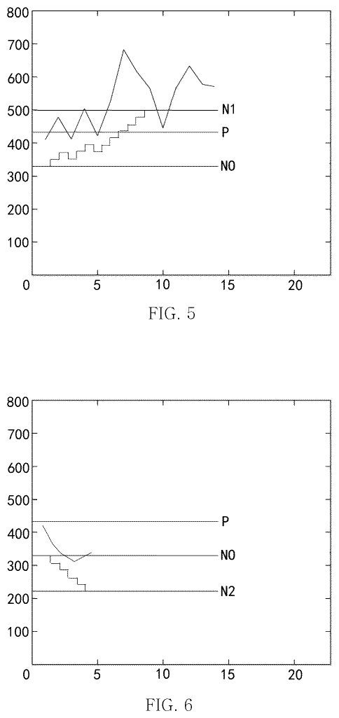

As shown in FIG. 5, if it is determined that the Mth integration value exceeds the integration threshold P, this indicates that the rollover angle of the vehicle about the rollover center O is rapidly increasing during the Mth time period, such that the vehicle may roll over about its longitudinal axis. Therefore, in Step 202, the count value is updated by adding one step size. Next, in Step 203, it is determined whether the updated count value exceeds the first count threshold N1. If it is determined that the updated count value exceeds the first count threshold N1, the process proceeds to Step 106. If it is determined that the updated count value is less than or equal to the first count threshold N1, the process returns to Step 104 to await the (M+1)th integration value corresponding to the (M+1)th time period (if any).

As shown in FIG. 6, conversely, if it is determined that the Mth integration value is less than or equal to the integration threshold P, this indicates that the rollover angle of the vehicle about the rollover center O is not rapidly increasing during the Mth time period, and the rollover about the rollover center O tends to stop. Therefore, in Step 204, the count value is updated by subtracting one step size. Next, in Step 205, it is determined whether the updated count value is less than the second count threshold N2. If it is determined that the updated count value is less than the second count threshold N2, the process proceeds to Step 107. If it is determined that the updated count value is greater than or equal to the second count threshold N2, the process returns to Step 104 to await the (M+1)th integration value corresponding to the (M+1)th time period (if any).

It is understood that, in FIGS. 5 and 6, the horizontal axis represents time and the vertical axis represents the magnitude of the integration value. It is further understood that the scale values of the horizontal and vertical axes are not limiting to this application. For example, herein, a time period may be 50 ms, but this is not required.

Herein, the integration value directly reflects the magnitude of the square of the angular velocity. Therefore, the step size may be set nonlinearly over time during the plurality of time periods to compensate for the result deviation caused by integrating the square of the angular velocity, rather than the angular velocity itself.

Optionally, based on the difference in duration between a vehicle undergoing a rollover and a vehicle undergoing a side collision, at least one of an initial value N0, a first count threshold N1, a second count threshold N2, and a step size may be set. Typically, the duration of a vehicle rollover generally exceeds 500 ms, whereas the duration of a side collision is generally less than 200 ms. In order to accurately distinguish whether the vehicle is undergoing a rollover or a side collision, at least one of the initial value N0, the first count threshold N1, and the step size may be set based at least on the total duration of the plurality of time periods during which the plurality of integration values continuously exceed the integration threshold P being greater than 500 ms. Additionally or alternatively, at least one of the initial value N0, the second count threshold N2, and the step size may be set based at least on the total duration of the plurality of time periods during which the plurality of integration values continuously do not exceed the integration threshold P being less than 200 ms. That is, the difference between the first count threshold N1 and the initial value N0 may be greater than the difference between the initial value N0 and the second count threshold N2. Optionally, the step size by which the count value increases when the plurality of integration values exceed the integration threshold P may be different from the step size by which the count value decreases when the plurality of integration values are less than or equal to the integration threshold P.

It is understood that the difference threshold, integration threshold P, initial value N0, first count threshold N1, second count threshold N2, step size, time period, and the like, as referenced herein, are all calibratable.

Optionally, in order to ensure that a large difference among the first acceleration, second acceleration, and third acceleration is caused by the vehicle rolling over about its longitudinal axis (for example, undergoing a rollover), rather than yawing about its vertical axis (the vertical axis being parallel to the Z-axis in the vehicle coordinate system) (for example, during steering), it may be determined, at least when acquiring the first acceleration, second acceleration, and third acceleration, that the vehicle is not yawing. For example, unit 50 may acquire an angle signal indicative of the steering angle of the steering wheel from an angle sensor associated with the vehicle's steering wheel, to determine whether the vehicle is steering about its vertical axis as required. If the steering angle is zero or less than or equal to an angle threshold, it is determined that the vehicle is not yawing. Additionally or alternatively, unit 50 may acquire a wheel speed signal indicative of the speed of a respective wheel from a wheel speed sensor associated with each wheel of the vehicle, to determine whether the vehicle is yawing about its vertical axis. If the difference among the wheel speeds of each wheel is less than or equal to a wheel speed threshold, it is determined that the vehicle is not yawing. Additionally or alternatively, unit 50 may acquire a torque signal indicative of the torque provided by a respective wheel motor from a torque sensor associated with each of the vehicle's wheel motors. If the difference among each of the torques is less than or equal to a torque threshold, it is determined that the vehicle is not yawing.

In one embodiment of the present application, a machine-readable storage medium is further provided, which stores executable instructions operable to run on a processor. When executed by the processor, the executable instructions cause the processor to perform the above method for determining whether a vehicle is undergoing a rollover.

In one embodiment of the present application, a computer program product is further provided, comprising executable instructions operable to run on a processor, which, when executed by the processor, implement the above method for determining whether a vehicle is undergoing a rollover.

The present application has been described in detail above in conjunction with specific embodiments. However, the above description and the embodiments shown in the accompanying drawings should be understood as illustrative and not as limiting the present application. Various modifications or alterations may be made by those skilled in the art without departing from the spirit of the present application, and all such modifications or alterations shall fall within the scope of the present application.

What is claimed is:

1. A method for determining whether a vehicle is undergoing a rollover, the vehicle including: a first acceleration sensor mounted on a first side of the vehicle in the lateral direction and configured to sense a first acceleration of the first side in the lateral direction; a second acceleration sensor mounted on a second side of the vehicle opposite to the first side in the lateral direction and configured to sense a second acceleration of the second side in the lateral direction; a third acceleration sensor mounted on an intermediate portion of the vehicle between the first side and the second side in the lateral direction and configured to sense a third acceleration of the intermediate portion in the lateral direction, wherein the method comprises:
acquiring the first acceleration, the second acceleration, and the third acceleration;
selecting the greater acceleration from the first acceleration and the second acceleration;
determining that a difference between the greater acceleration and the third acceleration exceeds a difference threshold;
integrating the difference over time during each of a plurality of consecutive time periods to generate a plurality of integration values;
determining whether a majority of the plurality of integration values exceed an integration threshold; and
when it is determined that a majority of the plurality of integration values exceed the integration threshold, determining that the vehicle is rolling over about its longitudinal axis; and
when it is determined that a majority of the plurality of integration values are less than or equal to the integration threshold, determining that the vehicle is not rolling over about its longitudinal axis.

2. The method according to claim 1, wherein determining whether a majority of the plurality of integration values exceed the integration threshold comprises:
providing a count value;
setting an initial value for the count value and a first count threshold greater than the initial value;
when it is determined that one of the plurality of integration values exceeds the integration threshold, updating the count value by adding a step size; and
when the updated count value exceeds the first count threshold, determining that a majority of the plurality of integration values exceed the integration threshold.

3. The method according to claim 2, wherein determining whether a majority of the plurality of integration values exceed the integration threshold further comprises:
setting a second count threshold less than the initial value;
when it is determined that one of the plurality of integration values is less than or equal to the integration threshold, updating the count value by subtracting a step size; and
when the updated count value is less than the second count threshold, determining that a majority of the plurality of integration values are less than or equal to the integration threshold.

4. The method according to claim 2, wherein the step size is set nonlinearly over time during the plurality of time periods.

5. The method according to claim 3, wherein at least one of the initial value, the first count threshold, the second count threshold, and the step size is set based on a difference in time duration between the vehicle rolling over and the vehicle undergoing a side collision.

6. The method according to claim 5, wherein at least one of the initial value, the first count threshold, and the step size is set at least based on a total time duration of the plurality of time periods being greater than 500 ms when the plurality of integration values continuously exceeds the integration threshold; and/or
wherein at least one of the initial value, the second count threshold, and the step size is set at least based on a total time duration of the plurality of time periods being less than 200 ms when the plurality of integration values continuously does not exceed the integration threshold.

7. The method according to claim 1, wherein, when acquiring the first acceleration, the second acceleration, and the third acceleration, low-pass filtering and/or offset elimination is performed on the first acceleration, the second acceleration, and the third acceleration.

8. The method according to claim 1, wherein, when acquiring the first acceleration, the second acceleration, and the third acceleration, it is determined that the vehicle is not yawing about its vertical axis.

9. A unit for determining whether a vehicle is undergoing a rollover, comprising:
a processor; and
a memory storing executable instructions, which, when executed, cause the processor to perform the method according to claim 1.

10. A system for determining whether a vehicle is undergoing a rollover, comprising:
a first acceleration sensor mounted on a first side of the vehicle in the lateral direction and configured to sense a first acceleration of the first side in the lateral direction;
a second acceleration sensor mounted on a second side of the vehicle opposite to the first side in the lateral direction and configured to sense a second acceleration of the second side in the lateral direction;
a third acceleration sensor mounted on an intermediate portion of the vehicle between the first side and the second side in the lateral direction and configured to sense a third acceleration of the intermediate portion in the lateral direction; and
the unit according to claim 9, the unit being communicatively connected to the first acceleration sensor, the second acceleration sensor, and the third acceleration sensor,
wherein the first acceleration sensor, the second acceleration sensor, and the third acceleration sensor are respectively mounted on the first side, the second side, and the intermediate portion at the same height in the lateral direction.

11. The system according to claim 10, further comprising at least one of the following sensors communicatively connected to the unit:
an angle sensor associated with a steering wheel of the vehicle, configured to sense a steering angle of the steering wheel so that the unit determines, based on the steering angle, whether the vehicle is yawing about its vertical axis;
a wheel speed sensor associated with each wheel of the vehicle, configured to sense a wheel speed of the respective wheel so that the unit determines, based on the wheel speed of each wheel, whether the vehicle is yawing about its vertical axis; and
a torque sensor associated with each of a plurality of wheel motors of the vehicle, configured to sense a torque provided by the respective wheel motor so that the unit determines, based on each torque, whether the vehicle is yawing about its vertical axis.
